(19) United States
(12) Patent Application Publication
(10) Pub. No.: US 2012/0194940 A1
(43) Pub. Date: Aug. 2, 2012

(54) MAGNETIC DISK DEVICE AND DATA VERIFICATION CONTROL METHOD IN THE DEVICE

(75) Inventor: Osamu YOSHIDA, Kawasaki-shi (JP)

(73) Assignee: KABUSHIKI KAISHA TOSHIBA, Tokyo (JP)

(21) Appl. No.: 13/361,827

(22) Filed: Jan. 30, 2012

(30) Foreign Application Priority Data
Jan. 31, 2011 (JP) 2011-019244

(51) Int. Cl. G11B 5/09

(52) U.S. Cl. 360/53; G9B/5.033

(57) ABSTRACT

According to one embodiment, a magnetic disk device having a disk, includes: a flag updating module configured to register a flag used when data is written onto the disk, the data is read from the disk and whether to verify the data or not is determined, so as to be associated with each of a plurality of predetermined temperature sections; a temperature detector configured to detect an environmental temperature of the magnetic disk device; a verifying module configured to determine whether to execute the verification or not according to a flag where the detected environmental temperature corresponds to one temperature section of the plurality of temperature sections and that is registered by the flag updating module so as to be associated with the one temperature section; and a measuring module configured to measure an error rate at a same point in time as the verification.

### CROSS REFERENCE TO RELATED APPLICATION(S)

The application is based upon and claims the benefit of priority from Japanese Patent Application No. 2011-019244 filed on Jan. 31, 2011, the entire contents of which are incorporated herein by reference.

### BACKGROUND

1. Field

Embodiments of the present invention relate to a magnetic disk device and a data verification control method in the device.

2. Description of the Related Art

In a magnetic disk device, data is written onto a disk (magnetic disk) as a recording medium by a head, and data stored on the disk is read by the head. This data writing/reading by the head is influenced by the environmental temperature of the magnetic disk device. For this reason, the magnetic disk device generally has an arrangement where optimum data writing/reading is always possible under a condition where the environmental temperature of the magnetic disk device is in a predetermined temperature range (e.g. the operation guarantee temperature range).

According to this arrangement, optimum writing/reading conditions are set according to the environmental temperature of the magnetic disk device. As writing/reading conditions, parameters such as writing current and a writing precompensation value are known.

Therefore, in order that optimum parameters can be set according to the environmental temperature of the magnetic disk device, a parameter table is used in which optimum parameters for predetermined temperatures (temperature ranges) Ti (i=1, 2, . . . , n) are set so as to be associated with the temperatures.

This parameter table is generally generated in the manufacturing process of the magnetic disk device.

Ideally, it is necessary to generate such a parameter table as contains all the conceivable environmental temperatures. However, to do so, a tremendous process time is required, and further, it is necessary to make the parameter table variably settable so as to contain all the environmental temperatures that are conceivable in the process equipment. For this reason, when these are difficult to perform, according to the prior art, there are cases where with respect to some temperatures (e.g. temperatures on a low temperature side) Tj, for the setting of the temperatures Tj and the optimum parameters at the temperatures Tj, the results of an actual measurement in a sample device and parameter values in another temperature environment of the target device where measurement has already been performed are combined to perform a calculation and the obtained values are made set values.

However, when a magnetic disk device is used at an environmental temperature for which parameters are unadjusted, it cannot be said that the efficiency of access from the host is never decreased by retry processing.

For example, to handle this access efficiency decrease, control related to a parameter adjustment method, or the like is performed.

Related arts describe a method of adjusting the reproduction laser power according to temperature changes with respect to a magneto-optical disk device. According to these methods, when the temperature change exceeds a predetermined threshold value, the laser power is readjusted. The physical place where the adjustment is made may be an area prepared for adjustment or an area already used by the user. In particular, since the present reference devices are laser power for reproduction, there is no significant difference therebetween. Moreover, when a temperature change is detected, the reproduction power adjustment is made each time it occurs.

The method in which the set value of the writing current is changed according to the temperature is described. This method uses default values set at the time of manufacture and the values of measurement by the device itself under a temperature environment. For example, when there is an access from a higher-level device and adjustment cannot be performed, the default set values are employed.

As described above, there are seen devices related to methods of adjusting parameters at the time of data writing. On the other hand, although there is a demand that the data verification control processing itself be omitted, no means for realizing such a demand is known.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing a typical structure of an electronic apparatus having a magnetic disk device of an embodiment;

FIG. 2 is a conceptual view showing an example of the format of the recording surfaces of a disk applied in the embodiment;

FIG. 3 is a view showing an example of the data structure of a parameter management table applied in the embodiment;

FIG. 4 is an identification flag table indicating that verification becomes unnecessary in a section of a zone 3 and a temperature of 10 degrees C.;

FIG. 5 is a flowchart showing a random writing operation of the embodiment; and

FIGS. 6A and 6B are explanatory views showing that in the embodiment, when verification is deemed unnecessary on a low temperature side, verification is also deemed unnecessary on a higher temperature side.

### DETAILED DESCRIPTION

According to one embodiment, a magnetic disk device having a disk, includes: a flag updating module configured to register a flag used when data is written onto the disk, the data is read from the disk and whether to verify the data or not is determined, so as to be associated with each of a plurality of predetermined temperature sections; a temperature detector configured to detect an environmental temperature of the magnetic disk device; a verifying module configured to determine whether to execute the verification or not according to a flag where the detected environmental temperature corresponds to one temperature section of the plurality of temperature sections and that is registered by the flag updating module so as to be associated with the one temperature section; and a measuring module configured to measure an error rate at a same point in time as the verification.

Hereinafter, embodiments will be described.

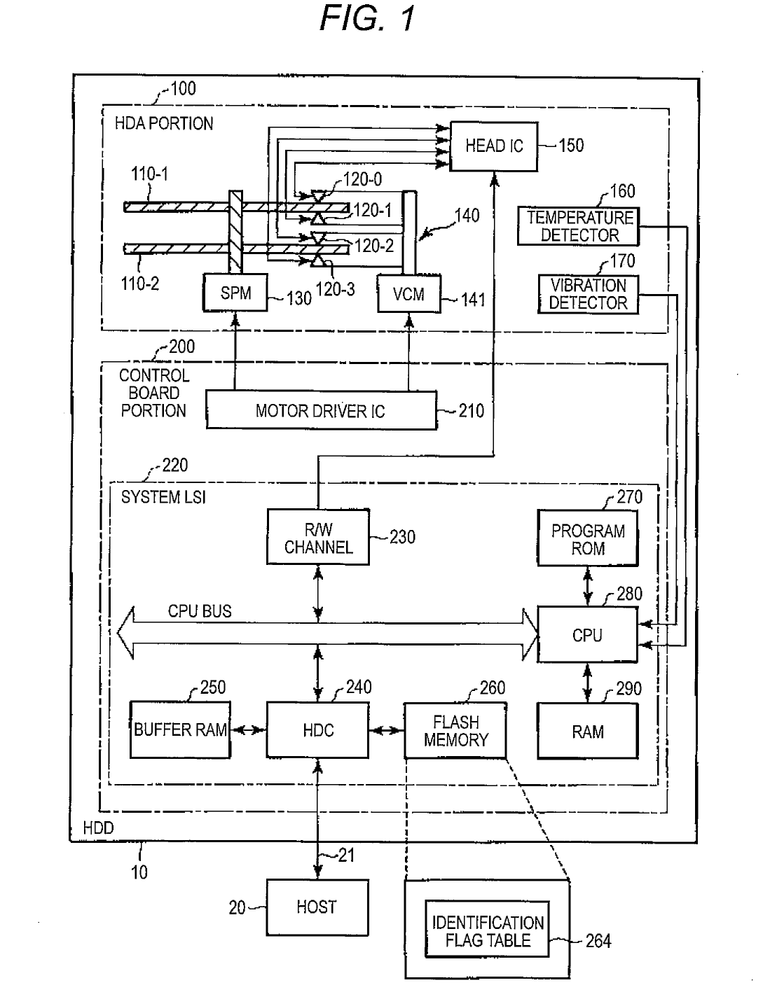

A first embodiment will be described with reference to FIGS. 1 to 5.

FIG. 1 is a block diagram showing a typical structure of an electronic apparatus having a magnetic disk device according to the first embodiment. In FIG. 1, the electronic apparatus includes a magnetic disk device (HDD) 10 and a host (host system) 20. The electronic apparatus is, for example, a personal computer, a video camera, a music player, a mobile terminal, or a mobile telephone. The host 20 uses the HDD 10 as a storage device of the host 20.

The HDD 10 includes a head disk assembly portion (HDA portion) 100 and a control board portion 200.

The HDA portion 100 includes, for example, two disks (magnetic disks) 110-1 and 110-2, a spindle motor (SPM) 130, an actuator 140, a head IC 150, a temperature detector 160, and a vibration detector 170.

The disks 110-1 and 110-2 each have upper and lower two recording surfaces. The disks 110-1 and 110-2 are rotated at high speed by the SPM 130. The disk 110-i (i=1, 2) employs a known recording format called CDR (constant density recording). Therefore, the recording surfaces of the disk 110-i are managed in a state of being divided into a plurality of zones in the radial direction of the disk 110-i. That is, the recording surfaces of the disk 110-i have a plurality of zones.

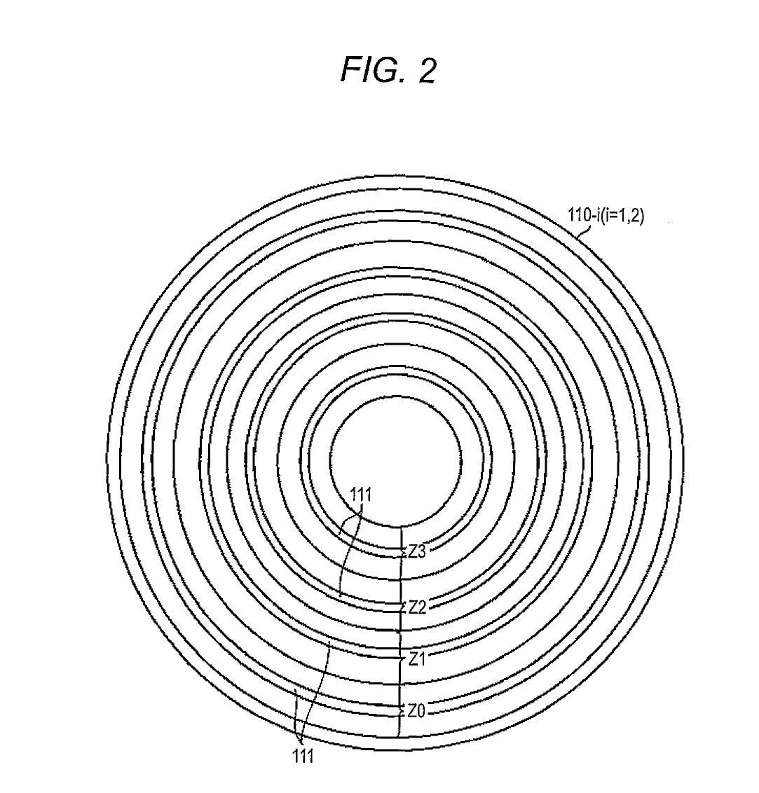

FIG. 2 is a conceptual view showing an example of the format of the recording surfaces of the disk 110-i. In the example of FIG. 2, for convenience of drawing, the recording surfaces of the disk 110-i are divided into four zones Z0 to Z3. However, the number of zones on the recording surfaces of the disk 110-i is not limited to four.

The zone Zp (p=0, 1, 2, 3) of the disk 110-i has a parameter adjustment area 111 used for parameter adjustment processing to adjust the parameters used when data is written into the user area in the zone Zp or when data is read from the user area in the zone Zp. In the parameter adjustment processing applied in the first embodiment, an operation of writing data into the parameter adjustment area 111, reading the data written in the parameter adjustment area 111 and calculating the error rate is performed while parameters are changed.

In the first embodiment, it is assumed that the parameter adjustment area 111 is situated on an inner circumference in the zone Zp and has at least one data track. In this case, the parameters adjusted by the parameter adjustment processing using the parameter adjustment area 111 are expected to be optimum for all the data tracks in the zone Zp.

For example, when the number of zones per recording surface of the disk 110-i is sufficiently large so that the surfaces are sufficiently finely divided, the parameter adjustment area 111 may be situated on either an inner circumference or an outer circumference side. Moreover, the parameter adjustment area 111 may be a partial area of one data track, that is, an area having fewer data sectors than one data track.

Referring again to FIG. 1, the actuator 140 has heads (magnetic heads) 120-0 and 120-1 at ends of head arms disposed in correspondence to the recording surfaces of the disk 110-1, respectively. The actuator 140 further has heads 120-2 and 120-3 at ends of head arms disposed in correspondence to the recording surfaces of the disk 110-2, respectively. The heads 120-0 and 120-1 are used for data writing/reading to/from the disk 110-1, and the heads 120-2 and 120-3 are used for data writing/reading to/from the disk 110-2.

The actuator 140 has a voice coil motor (VCM) 141. The actuator 140 is driven by the VCM 141, and moves the heads 120-0 to 120-3 in the radial direction of the disks 110-1 and 110-2.

The SPM 130 and the VCM 141 are driven by driving currents (an SPM current and a VCM current) supplied from a motor driver IC 210 described later.

The head IC 150 amplifies the signal (reading signal) read by the head 120-j (j=0, 1, 2, 3). The head IC 150 also converts the writing data transferred from a reading/writing channel 230 described later, into a writing current, and outputs it to the head 120-j.

The temperature detector 160 detects the temperature (environmental temperature) T in the environment where the HDD 10 is used. The vibration detector 170 detects the vibration applied to the HDD 10 from the outside of the HDD 10.

The control board portion 200 includes two LSIs, the motor driver IC 210, and a system LSI 220. The motor driver IC 210 drives the SPM 130 at constant rotation speed. The motor driver IC 210 also drives the actuator 140 by supplying the VCM 141 with a current (VCM current) of a value corresponding to the VCM operation amount specified by a CPU 270.

The system LSI 220 is an LSI called an SOC (System on Chip) where the reading/writing channel (R/W channel) 230, a disk controller (HDC) 240, a buffer RAM 250, a flash memory 260, a program ROM 270, a CPU 280, and a RAM 290 are integrated on a single chip.

The R/W channel 230 is a signal processing device that performs signal processing related to reading and writing. The R/W channel 230 converts the reading signal into digital data, and decodes the digital data into the reading data. The R/W channel 230 also extracts the servo data necessary for positioning the head 120-j, from the digital data. The R/W channel 230 also codes the writing data.

The HDC 240 is connected to the host 20 through a host interface 21. The HDC 240 receives commands (a writing command, a reading command, etc.) transferred from the host 20. The HDC 240 controls the data transfer between the host 20 and the HDC 240. The HDC 240 controls the data transfer between the disk 110-i (i=1, 2) and the HDC 240 performed through the R/W channel 230.

The buffer RAM 250 is used for temporarily storing data to be written onto the disk 110-i and data read from the disk 101-i through the head IC 150 and the R/W channel 230.

The flash memory 260 is a rewritable nonvolatile memory. The flash memory 260 is used for storing a parameter management table 261 and an identification flag table 264 described later.

The program ROM 270 prestores control programs (firmware programs). The control programs may be stored in a partial area of the flash memory 260.

The CPU 280 functions as a main controller of the HDD 10. The CPU 280 controls at least some of the other elements in the HDD 10 according to the control programs stored in the program ROM 270. A partial area of the RAM 290 is used as the work area of the CPU 280. In this work area, the parameter management table 261 and the identification flag table 264 stored in the flash memory 260 are loaded when the HDD 10 is powered on.

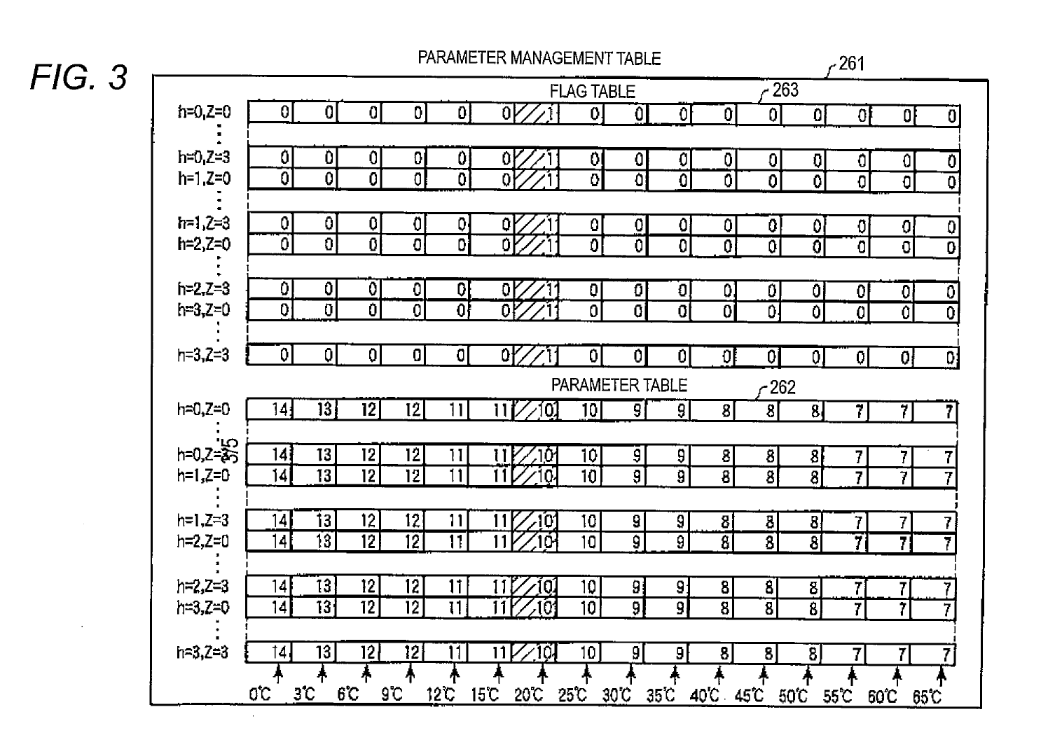

FIG. 3 shows an example of the data structure of the parameter management table 261.

The parameter management table 261 includes a parameter table 262 and a flag table 263.

In the parameter table 262, parameters are registered so as to be associated with a plurality of predetermined temperature sections Tq (q=1, 2, . . . , n) for each of the heads 120-j (j=0, 1, 2, 3) corresponding to the recording surfaces of the disks 110-1 and 110-2 and for each of the zones Zp (p=0, 1, 2, 3). In the first embodiment, when the temperature T is detected by the temperature detector 160, it is determined to which of the plurality of temperature sections Tq the temperature T corresponds.

The reason that the parameters are associated not only with the temperature section Tq but also with the head 120-j and the zone Zp in the first embodiment is because it is taken into consideration that the reading/writing characteristics of the HDD 10 differ according not only to the temperature section Tq but also to the head 120-j and the zone Zp. However, the parameters may be associated only with the temperature section Tq or may be associated with a combination of the temperature section Tq and either the head 120-j or the zone Zp.

In the first embodiment, the head 120-j is assigned with a head number h (h=j), and the zone Zp is assigned with a zone number z (z=p). That is, in the parameter table 262, parameters are registered so as to be associated with the plurality of temperature sections Tq for each combination of the head number h (h=0, 1, 2, 3) and the zone number z (z=0, 1, 2, 3). The parameter table 262 shown in FIG. 3 is made on the assumption that the writing current is the only parameter for simplification of explanation. However, the writing precompensation value may be included in the parameters.

In the flag table 263, a flag F is registered so as to be associated with the plurality of temperature sections Tq for each of the heads 120-j corresponding to the recording surfaces of the disks 110-1 and 110-2 and for each of the zones Zp. That is, in the flag table 263, the flag F is registered so as to be associated with the plurality of temperature sections Tq for each combination of the head number h (h=0, 1, 2, 3) and the zone number z (z=0, 1, 2, 3).

The flag F corresponding to the combination (h, z, Tq) of the head 120-j (h=j), the zone Zp (z=p) and the temperature section Tq which flag F is registered in the flag table 263 indicates whether the parameter corresponding to the combination (h, z, Tq) which parameter is registered in the parameter table 262 has been adjusted or is unadjusted, that is, the presence or absence of the adjustment. In the example of FIG. 3, the flag F being “1” indicates that the corresponding parameter has been adjusted, and the flag F being “0” indicates that the corresponding parameter is unadjusted. In the following description, the temperature section Tq to which the flag F indicating having been adjusted corresponds will be called an adjusted point, and the temperature section Tq to which the flag F indicating being unadjusted corresponds will be called an unadjusted point.

In the example of FIG. 3, for convenience of drawing, the temperature interval between the adjoining temperature sections Tq and Tq+1 imparatively large. However, in the first embodiment, for example, it is assumed that the temperature sections are finely set to such an extent that normal reading and writing can be performed even when the parameter associated with the adjoining temperature section Tq−1 or Tq+1 is used in a case where the temperature T detected by the temperature detector 160 belongs to (that is, corresponds to) the temperature section Tq. In this case, the parameter associated with the temperature section Tq to which the detected temperature T belongs can be used as it is without the need for, for example, linear interpolation processing. Consequently, the parameter values used for reading and writing can be prevented from deviating from the optimum values.

Moreover, in the example of FIG. 3, for the sake of simplification, integers are used as the parameters registered in the parameter management table 261 (parameter table 262). However, to improve the accuracy of the interpolation processing described later, numerical values with a decimal point may be used as the parameters registered in the parameter management table 261. However, a register used for parameter setting for disk access generally holds integral values. Therefore, when parameters which are numerical values with a decimal point are used, the integral parts of the parameters are set in the register. Moreover, the temperature sections maybe set with a temperature difference corresponding to the resolution of the register, that is, the numerical value “1”. When such temperature sections are applied, it is expected that reading and writing can be normally performed even when a parameter associated with an adjoining temperature section is used. However, temperature sections of a temperature difference corresponding to a numerical value higher than “1” may be set.

The parameter management table 261 of FIG. 3 shows the condition at the time of shipment of the HDD 10 provided with the parameter management table 261. In the example of FIG. 3, the flag table 263 in the parameter management table 261 indicates that, of the parameters of the temperature sections Tq in combinations of head numbers h of 0 to 3 (heads 120-0 to 120-3) and zone numbers z of 0 to 3 (zones Z0 to Z3), only the parameter corresponding to the temperature section Tq of 20 degrees C. (so-called ordinary temperature) has been adjusted and the parameters corresponding to the other temperature sections are all unadjusted.

As described above, in the first embodiment, in the process of manufacturing the HDD 10, only the parameter corresponding to the temperature section Tq of 20 degrees C. is adjusted for each combination of the head number h and the zone number z. For the parameters corresponding to all the temperature sections, except that of 20 degrees C., of the plurality of temperature sections Tq, predetermined default values (provisional values) are used as the unadjusted parameters. The parameter adjustment in the process of manufacturing the HDD 10 may be performed for a temperature section other than 20 degrees C. such as 60 degrees C., or may be performed with two or more temperature sections such as 20 degrees C. and 60 degrees C.

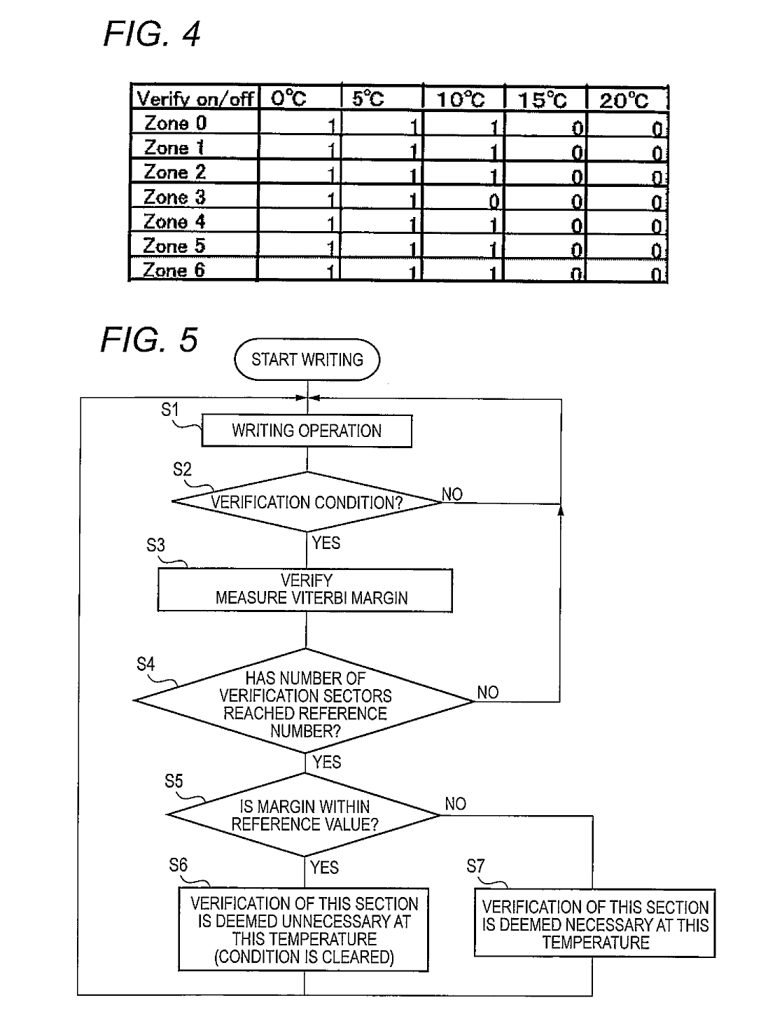

FIG. 4 shows a data structure example of the identification flag table 264. The temperature sections of the identification flag table 264 may be different from those of the parameter management table 261 (in this example, divided in units of five degrees). In the structure example shown in FIG. 4, the head sections are omitted. In this example, “1” represents a set condition (verify on) where the flag is on, and “0” represents a reset condition (verify off) where the flag is cleared. This flag is a value for determining whether the verification processing is executed (on) or not executed (off). Set frames determined by a matrix of temperatures and zones and to which flags are set will be called cells.

Next, the operation of the HDD 10 in the electronic apparatus shown in FIG. 1 will be described with reference to the flowchart of FIG. 5.

First, when the HDD 10 is powered on, the parameter management table 261 and the identification flag table 264 stored in the flash memory 260 are loaded into the RAM 290 under the control of the CPU 280. Therefore, in the following description of FIG. 5, it is assumed that the parameter management table 261 and the identification flag table 264 are stored in the RAM 290.

Under the condition where the HDD 10 is powered on, the CPU 280 reads the temperature (that is, the environmental temperature of the HDD 10) T detected by the temperature detector 160, steadily or at predetermined time intervals. Then, the CPU 280 identifies the temperature section Tq to which the temperature T belongs, from among the plurality of temperature sections Tq.

When a writing operation at a low temperature is performed, if the temperature reaches the verification activation condition, the HDC 240 performs the verification processing after writing, and measures the viterbi margin or the error rate.

For example, it is assumed that the HDD 240 performs data writing with a head in an environment of the zone 3 and a temperature of 10 degrees C.

In this case, if “1” is set in the cell on the identification flag table 264 corresponding to the zone 3 and a temperature of 10 degrees C., the verification operation is activated after the writing operation (step S1) (yes of step S2). If “1” is not set in the cell, the next writing operation is executed (no of step S2).

In this verification operation, as described above, the measurement of the viterbi margin or the error rate is performed at the same time (step S3).

When the measured number of verification sectors satisfies the above-mentioned defined number of sectors (yes of step S4) and the error rate falls within the predetermined threshold value (yes of step S5), it is determined that the verification operation can be omitted in the subsequent writing operation under the condition of the zone 3 and a temperature of 10 degrees C. At this time, the identification flag table 264 is updated as shown in FIG. 4 by the HDC 240. That is, the cell of the zone 3 and a temperature of 10 degrees C. is updated from 1 to 0 as in FIG. 4.

When the number of sectors is not satisfied in the above (no of step S4), the next writing operation is executed. Moreover, when the error rate does not fall within the predetermined threshold value (no of step S5), the cell is held unchanged at “1”. That is, the next time the same temperature is detected, the verification processing is executed after the writing processing. While the operation on the low temperature side has been described, a similar operation may be executed on the high temperature side.

A second embodiment according to the present invention will be described with reference to FIGS. 1 to 6B. Description of parts common to those of the first embodiment is omitted.

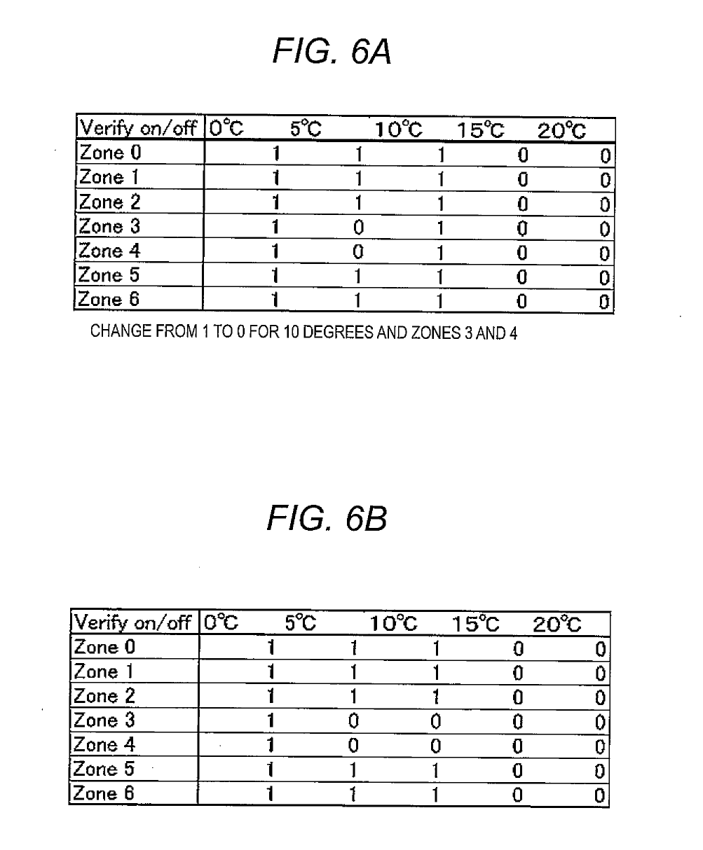

FIGS. 6A and 6B are explanatory views showing that, when it is determined that the verification processing is unnecessary on a low temperature side, it is determined that the verification processing is also unnecessary on a higher temperature side (the ordinary temperature side where the parameter is adjusted). Although the description of the higher temperature side is omitted, if the operating range is up to 65 degrees C., the identification flag table is extended to 65 degrees C. in increments of 5 degrees C. from 25 degrees C. In this extension range, when it is determined that verification is unnecessary on the high temperature side, the processing is such that verification is also unnecessary on the lower temperature side (the ordinary temperature side where the parameter is adjusted) between the ordinary temperature where the parameter has been adjusted and the present temperature.

An example will be described in which the temperature when data writing processing is performed is 5 degrees C. In this case also, determination is made as to whether to perform the verification processing similar to that of the operation 1 or not and whether verification is necessary hereafter or not.

When verification is unnecessary, the table is updated as shown in FIG. 6A.

In this instance, there are cases where data writing has not been performed yet in the environment of the zone 3 and 10 degrees C. In such cases, it can be determined that verification may be omitted for the cells of the table the temperatures of which are on the side closer to the ordinary temperature. In this case, the table is further updated as in FIG. 6B.

The determination processing of the above-described embodiments may be re-performed every power-on of the HDD, or this data may be recorded in a medium and developed into memory at the time of power-on to continue the previous result.

Further, to handle aging, a processing to regularly return the table to the default condition may be performed after the elapse of a predetermined period of time.

The timing of the recording into a medium may be the timing of power saving or unloading processing.

When the error rate does not fall within the threshold value, the verification operation is not omitted. Moreover, in an environment where the verification omission condition of the present embodiment is not reached and the verification operation is necessary, the set parameter is adjusted, and at the point in time when the adjustment is completed, the corresponding part on the table is changed from 1 to 0.

This is because the omission of the verification operation is enabled by making it possible to adopt the adjusted parameter at the next access thereafter.

As the means for parameter adjustment, a known technology is used.

In an environment where performance degradation is not allowed, since it is necessary to avoid verification as much as possible, the degradation in I/O performance due to verification can be prevented by holding the adjusted parameter and reusing it.

Effects of the above-described embodiments will be cited.

(1) Prevention of performance degradation under a low temperature condition or a high temperature condition by a control method where the verification processing is avoided as much as possible.

(2) Prevention of increase in manufacturing cost (the performance of initial adjustment with a limited temperature range)

Characteristics of the above-described embodiments will be cited.

a) The embodiments are characterized by having the identification flag table for identifying places requiring verification and places not requiring verification in correspondence to the division table divided by heads, zones and temperatures.

b) Temperature is monitored at all times, and it is found whether verification is necessary or unnecessary in each section of the parameter table to which the current temperature corresponds.

c) When verification is necessary, verification is performed immediately after the writing operation. At this time, the error rate is simultaneously measured.

d) When the error rate is excellent, thereafter, the verification in the section is deemed unnecessary, and the identification flag table is updated so that this is indicated.

e) The cell on the side, of the cell where it has already been determined that adjustment has been made or verification is unnecessary, of the cell where verification is deemed unnecessary is unconditionally set such that verification is unnecessary.

While certain embodiments have been described, these embodiments have been presented by way of example only, and are not intended to limit the scope of the inventions. Indeed, the novel methods and systems described herein maybe embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a temperature detector configured to detect an environmental temperature;
a flag updater configured to register a flag associated with a temperature section of a plurality of temperature sections, the temperature section corresponding to the environmental temperature;
a verifier configured to determine whether to execute a verification based on the flag; and
a measuring module configured to measure an error rate at a same time as the verification.

2. The magnetic disk device of claim 1, wherein
when a first flag associated with a first temperature section is not set, the flag updater is configured to update a second flag associated with a second temperature section on an ordinary temperature side of the first temperature section to an unset condition.

3. The magnetic disk device of claim 1, wherein
when the error rate is higher than a first value, the flag updater is configured to set the flag.

4. The magnetic disk device of claim 3, further comprising
a parameter adjuster configured to adjust a parameter associated with the environmental temperature to be suitable for the environmental temperature when the error rate is higher than the first value.

5. A data verification control method in a magnetic disk device, comprising:
identifying a temperature section of a plurality of temperature sections, the temperature section corresponds to an environmental temperature detected by a temperature detector;
registering a flag in an identification flag table, the flag is associated with the temperature section; and
determining whether to execute a verification based on the flag.

6. The data verification control method of claim 5, wherein
when a first flag associated with a first temperature section is not set, a second flag associated with a second temperature section on an ordinary temperature side of the first temperature section is updated to an unset condition.

7. The data verification control method of claim 5, wherein
when the error rate measured at a same time as the verification is higher than a first value, the flag is set.

8. The data verification control method of claim 7, further comprising
adjusting a parameter associated with the environmental temperature to be suitable for the environmental temperature when the error rate is higher than the first value.
